(19) United States
(12) Patent Application Publication
(10) Pub. No.: US 2013/0290412 A1
(43) Pub. Date: Oct. 31, 2013

(54) METHOD, APPARATUS, AND SYSTEM FOR DATA TASK PROCESSING

(71) Applicants: PEKING UNIVERSITY FOUNDER GROUP CO., LTD., Beijing (CN); BEIJING FOUNDER APABI TECHNOLOGY LTD., Beijing (CN)

(72) Inventors: Jinbing YAN, Beijing (CN); Jianbo XU, Beijing (CN); Leilei GENG, Beijing (CN)

(73) Assignees: BEIJING FOUNDER APABI TECHNOLOGY LTD., Beijing (CN); PEKING UNIVERSITY FOUNDER GROUP CO., LTD., Beijing (CN)

(21) Appl. No.: 13/871,820

(22) Filed: Apr. 26, 2013

(30) Foreign Application Priority Data
Apr. 27, 2012 (CN) 201210129968.5

(51) Int. Cl. H04L 29/06

(52) U.S. Cl. CPC H04L 29/06047
USPC 709/203

(57) ABSTRACT

A system for data task processing includes a master server, a client server, and a plurality of destination servers. The master server may be configured to receive a task assignment request from the client server, transmit the task corresponding to the task assignment request to the client server, and receive a processing result of the task from the client server. The client server may be configured to receive a task from the master server and parse the task to obtain task parameters of the task. The task parameters may include a type of the task. The client server may further be configured to transmit the task parameters to one of the destination servers according to the type of the task. The destination servers may be configured to process tasks of different types.

### CROSS-REFERENCE TO RELATED APPLICATION

This application is based upon and claims benefit of priority from Chinese Patent Application No. 201210129968.5, filed Apr. 27, 2012, the entire content of which is incorporated herein by reference.

### FIELD

The present disclosure relates to electronic document processing and, more particularly, to a method, apparatus, and system for data task processing.

### BACKGROUND

Data processing may involve a large amount of repetitive complex calculations, which are time-consuming and complicated to manage. Manually performing these calculations is a waste of human resources and cannot guarantee quality. Moreover, the number of machines participating in data processing cannot be adjusted dynamically according to the amount of data for processing. As a consequence, rapid response to data processing cannot be realized. In conventional data processing, because of the diversity and complexity of formats of data to be processed, interruption or even breakdown of the entire processing procedure often occurs due to an error in a part of the data. In addition, source of the error often cannot be precisely located.

### SUMMARY

In accordance with the present disclosure, there is provided a system for data task processing. The system includes a master server, a client server, and a plurality of destination servers. The destination servers are configured to process tasks of different types. The client server is configured to receive a task from the master server and parse the task to obtain task parameters of the task. The task parameters include a type of the task. The client server is further configured to transmit the task parameters to one of the destination servers according to the type of the task.

Also in accordance with the present disclosure, there is provided a client server. The client server includes a receiving module, a parsing module, and a transmitting module. The receiving module is configured to receive a task from a master server. The parsing module is configured to parse the task to obtain task parameters of the task. The task parameters include a type of the task. The transmitting module is configured to transmit the task parameters to a destination server according to the type of the task.

Also in accordance with the present disclosure, there is provided a method for data task processing. The method includes receiving, by a client server, a task from a master server, and parsing the task to obtain task parameters of the task. The task parameters include a type of the task. The method further includes transmitting the task parameters to a destination server according to the type of the task.

Features and advantages consistent with the disclosure will be set forth in part in the description which follows, and in part will be obvious from the description, or may be learned by practice of the disclosure. Such features and advantages will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a block diagram showing a system according to an exemplary embodiment.

FIG. 2 is a block diagram showing a master server according to an exemplary embodiment.

FIG. 3 is a block diagram showing a processing module in the master server according to an exemplary embodiment.

FIG. 4 is a block diagram showing a client server according to an exemplary embodiment.

FIG. 5 is a flow chart showing a method according to an exemplary embodiment.

FIG. 6 is an operation flow chart of a system according to an exemplary embodiment.

### DETAILED DESCRIPTION

Embodiments consistent with the present disclosure include a method and system for data task processing, where tasks that can be run in parallel are distributed and processed based upon distributed processors to thereby improve the efficiency of content processing while guaranteeing the stability of the processing system.

Repetitive complex tasks may be processed in parallel, with a master server performing centralized management and distributing the tasks to client servers. Clients may be managed and controlled automatically according to performances of the clients. In some embodiments, the number of client servers may be determined according to the amount of tasks to be processed.

Hereinafter, embodiments consistent with the disclosure will be described with reference to drawings. Wherever possible, the same reference numbers will be used throughout the drawings to refer to the same or like parts.

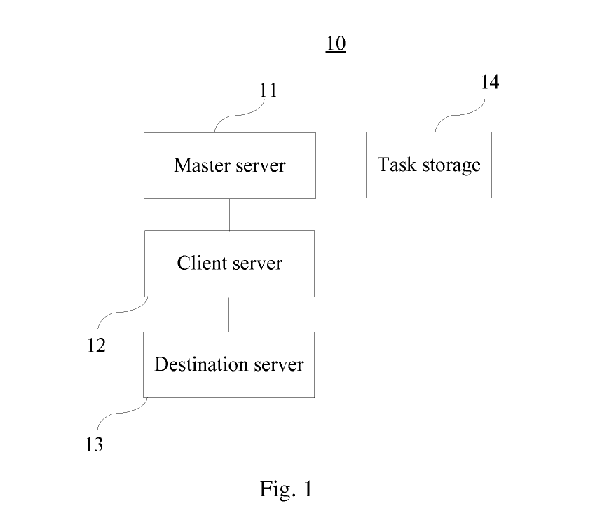

FIG. 1 shows a system 10 consistent with embodiments of the present disclosure for data task processing. The system 10 includes a master server 11, a client server 12, and a destination server 13. The client server 12 may be configured to transmit a task assignment request to the master server 11 according to an operating status thereof, to receive a task transmitted back from the master server 11 in response to the task assignment request, to parse the task for task parameters of the task (including, for example, size, type, and the storage location information of the task), to transmit the task parameters to the destination server 13, to receive a processing result fed back from the destination server 13, and to transmit the processing result to the master server 11. In some embodiments, the processing result may include, for example, task execution success, task execution failure, reason for the failure, type of the failure, and step(s) causing the failure. The master server 11 may be configured to receive the task assignment request transmitted from the client server 12 and to transmit the task corresponding to the task assignment request to the client server 12. The destination server 13 may be configured to process the task according to the received task parameters.

As shown in FIG. 1, the system 10 further includes a task storage 14 storing tasks. The master server 11 may obtain the corresponding task from the task storage 14 according to the task assignment request. In some embodiments, the task storage 14 is configured to search the corresponding task in a data table of its own, and transmits the found unexecuted task to the master server 11, which in turn transmits the unexecuted task to the client server 11. In some embodiments, the master server 11 may receive the task corresponding to the task assignment request, parses the task for the corresponding task parameters, and transmits the task parameters, such as size, type, and storage location of the task, as well as the type of the processor required for processing the task, to the destination server 13. For different types of tasks, different destination servers may be selected to execute the task processing.

The destination server 13 may transmit the processing result of the task to the master server 11 upon completion of the corresponding task. For each task, a task result record is generated, such as, for example, task execution success, task execution failure, the type of reason corresponding to the failure, and the step at which the task fails.

The master server 11 may add the received processing result to a log table of the task storage 14 and create a one-to-one mapping between the task and the processing result in the log table. The master server 11 may further be configured to store the processing result. When the task execution fails, the master server 11 may determine whether the destination server currently executing the corresponding task matches the task, according to the type of reason for the failure. For example, if an operating environment of the destination server currently executing the corresponding task is not suitable for the execution of the task, then the master server may further select an appropriate destination server to process the task again.

Specifically, the destination server 13 may generate the corresponding task result record according to the execution result of the task and feed back the task result record to the client server 12. In some embodiments, the task result record may include at least task execution success, task execution failure, a failure reason, or a location at which the failure occurs. The client server 12 may transmit the task result record to the master server 11. The master server 11 may add the received task result record to the log table of the task storage 14 and updates the log table.

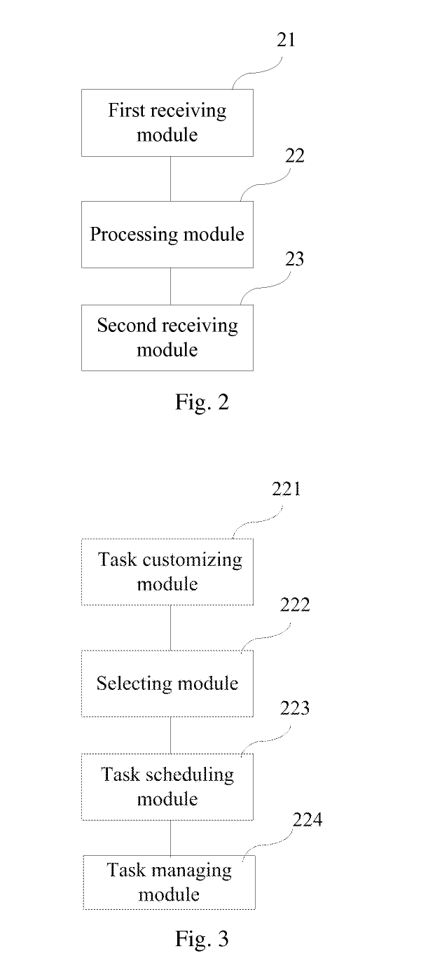

FIG. 2 is a block diagram schematically showing a structure of the master server 11 according to an exemplary embodiment. As shown in FIG. 2, the master server 11 may include the following components.

A first receiving module 21, configured to receive a task assignment request transmitted from the client server 12.

A processing module 22, configured to determine a corresponding task according to the task assignment request and to transmit the task to the client server 12.

A second receiving module 23, configured to receive a processing result transmitted from the client server 12, fed back from the destination server 13.

FIG. 3 is a block diagram schematically showing a structure of the processing module 22 in the master server 11 according to an exemplary embodiment. As shown in FIG. 3, the processing module 22 may include a task customizing module 221, a selecting module 222, a task scheduling module 223, and a task managing module 224. The task customizing module is configured to set types of tasks. Different types of tasks are stored differently. In some embodiments, the selecting module 222 may be configured to select a client server for processing a task according to the type of the task. The task scheduling module 223 is configured to create a mapping between a task result record and a task corresponding thereto, and to add the mapping to the log table. The task managing module 224 may be configured to manage a period of time during which the client server executes the task and to control the start and stop of the execution of the task. An example is described below wherein a website may act as a master server 11. In this example, a client (equivalent to a destination server) is selected to execute a task, such as downloading, uploading, or transmitting an email, according to the type, size, and other parameters of the task. For example, clients are selected according to different types of tasks. A result record, transmitted from the client, of executing the task is received, such as, for example, download success or download failure. When the download fails, a failure reason and a step at which the failure occurs will be transmitted to the website side.

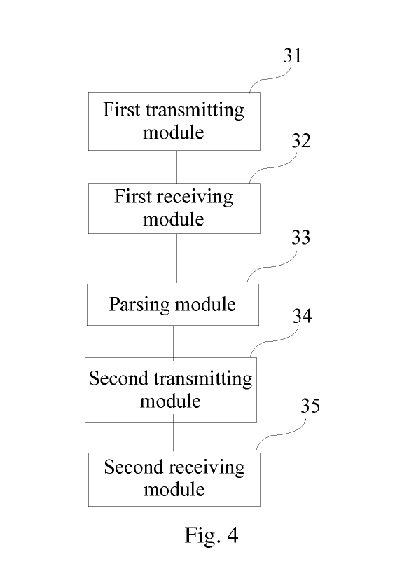

FIG. 4 is a block diagram schematically showing a structure of a client server 12 according to an exemplary embodiment. The client server 12 may include the following components.

A first transmitting module 31, configured to transmit a task assignment request to a master server 11 according to an operating status thereof.

A first receiving module 32, configured to receive a task transmitted back from the master server 11 in response to the task assignment request.

A parsing module 33, configured to parse the task for task parameters of the task.

A second transmitting module 34, configured to transmit the task parameters resulting from parsing to a destination server 13 so that the destination server 13 can process the task.

A second receiving module 35, configured to receive a processing result of the task fed back from the destination server 13 and to transmit the processing result to the master server 11.

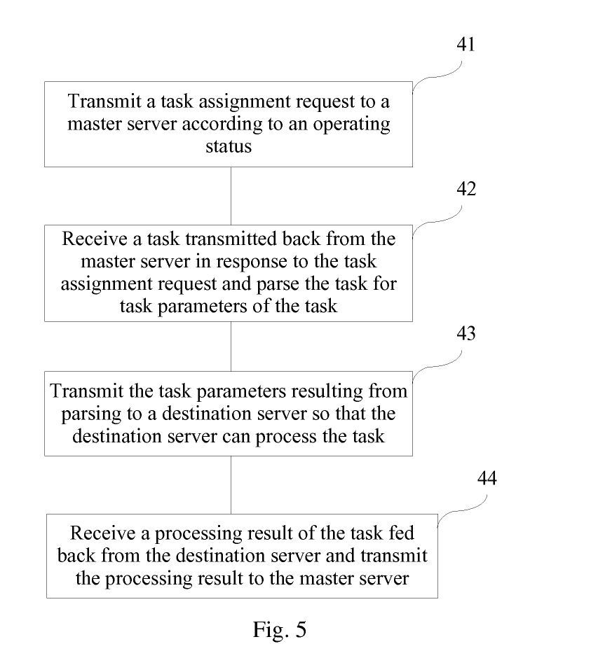

FIG. 5 is a flow chart schematically showing a method according to an exemplary embodiment. The method includes the following steps.

At step 41, the client server 12 transmits a task assignment request to a master server 11 according to an operating status of the client server 12.

At step 42, the client server 12 receives a task transmitted back from the master server 11 in response to the task assignment request, and parse the task for task parameters of the task.

At step 43, the client server 12 transmits the task parameters resulting from the parsing to a destination server 13 so that the destination server 13 can process the task.

At step 44, the client server 12 receives a processing result of the task fed back from the destination server 13, and transmit the processing result to the master server 11.

In some embodiments, master server 11 may obtain the task from a task storage 14 according to the task assignment request and transmit the task to the client server 12.

In some embodiments, after receiving the processing result corresponding to the task fed back from the destination server 13 and transmitting the processing result to the master server 11, the method may further include that the master server 11 adds the received processing result to a log table of the task storage 14 and creates a one-to-one mapping to the task.

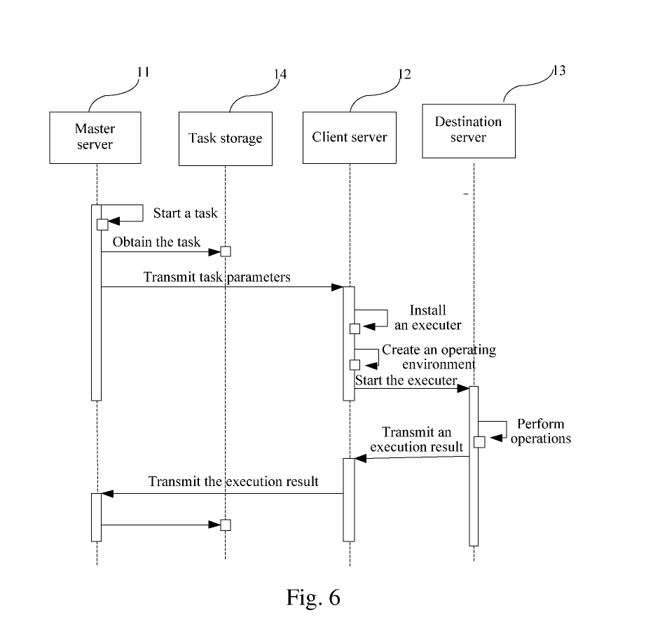

FIG. 6 is an operation flow chart for a system according to an exemplary embodiment. The system includes a master server 11, a task storage 14, a client server 12, and a destination server 13. The operation flow includes the following.

The master server 11 may start execution of a task.

The master server 11 may obtain the task from the task storage 14. In some embodiments, the master server 11 may also parse the task for the type thereof and transmits parameters corresponding to the task to the client server 12.

The client server 12 may install an executor according to the type of the task, obtains prior data and conditions required for executing the task, creates an operating environment, and starts the executor.

The client server 12 may transmit the obtained prior data and conditions required for executing the task to the destination server 13 for processing.

The destination server 13 may execute the task to obtain a result and feeds the execution result corresponding to the task back to the client server 12.

The client server 12 may transmit the execution result to the master server 11.

The master server 11 may add the execution result to a log table of the task and stores it into the task storage 14.

In some embodiments, if the task fails, the master server 11 may further perform a corresponding process according to a failure reason.

In a system according to some embodiments of the present disclosure, a master server 11 may distribute repetitive complex calculations to a plurality of client servers 12 for concurrent execution. The master server 11 can manage assignment of a task automatically, and can collect a result and handle an error. Therefore, automatic management of a data processing flow is realized, freeing personnel from burdensome processing flow, and thus the quality of data processing can be improved while saving human resources.

Moreover, methods consistent with embodiments of the present disclosure are rapid and efficient. The number of devices participating in data processing may be dynamically adjusted according to the amount of data tasks, which saves a lot of time and improves the efficiency of operation.

Methods consistent with embodiments of the present disclosure have an automatic correction capability. A problem occurring at one step will neither influence the entire system nor cause a knock-on effect in subsequent operation processes.

Methods consistent with embodiments of the present disclosure are flexible. In some embodiments, the task type being executed by a client may be selected based on need, and a different client server may be configured to perform a task.

Methods consistent with embodiments of the present disclosure may also be automated. A digital task can be processed without any human intervention and the system can automatically perform respective steps.

The present disclosure has been described with reference to embodiments of methods, apparatuses (systems), and flow charts and/or block diagrams of computer program products. It shall be appreciated that respective flows and/or blocks in the flow charts and/or the block diagrams and combinations of flows and/or blocks in the flow charts and/or the block diagrams may be embodied in computer program instructions. These computer program instructions can be loaded onto a general-purpose computer, a specific-purpose computer, an embedded processor, or a processor of another programmable data processing device to produce a machine so that the instructions executed on the computer or the processor of the other programmable data processing device create means for performing the functions specified in the flow(s) of the flow charts and/or the block(s) of the block diagrams.

These computer program instructions can also be stored into a computer readable memory capable of directing the computer or the other programmable data processing device to operate in a specific manner so that the instructions stored in the computer readable memory create manufactures including instruction means which perform the functions specified in the flow(s) of the flow charts and/or the block(s) of the block diagrams.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow charts and/or the block(s) of the block diagrams.

Although the preferred embodiments of the present disclosure have been described, those skilled in the art benefiting from the underlying inventive concept can make additional modifications and variations to these embodiments. Therefore the appended claims are intended to be construed as encompassing the embodiments and all the modifications and variations falling in the scope of the present disclosure.

Evidently those skilled in the art can make various modifications and variations to the present disclosure without departing from the spirit and scope of the present disclosure. Thus the present disclosure is also intended to encompass these modifications and variations thereto so long as these modifications and variations fall in the scope of the claims appended to the p and their equivalents.

1. A system for data task processing comprising:
a master server;
a client server; and
a plurality of destination servers,
wherein the client server is configured to:
receive a task from the master server,
parse the task to obtain task parameters of the task, the task parameters including a type of the task, and
transmit the task parameters to one of the destination servers according to the type of the task, and
wherein the destination servers are configured to process tasks of different types.

2. The system according to claim 1, wherein the client server is further configured to:
transmit a task assignment request to the master server according to an operating status of the client server,
receive a processing result of the task from the one of the destination servers, and
transmitting the processing result to the master server.

3. The system according to claim 1, wherein the master server is configured to:
receive a task assignment request from the client server,
transmit the task corresponding to the task assignment request to the client server, and
receive a processing result of the task from the client server.

4. The system according to claim 3, further comprising:
a task storage storing tasks,
wherein the master server is further configured to retrieve the task from the task storage according to the task assignment request.

5. The system according to claim 4, wherein the master server is further configured to:
add the processing result to a log table of the task storage, and
create a one-to-one mapping between the task and the processing result.

6. The system according to claim 3, wherein the master server is further configured to store the processing result.

7. A client server comprising:
a receiving module configured to receive a task from a master server;
a parsing module configured to parse the task to obtain task parameters of the task, the task parameters including a type of the task; and
a transmitting module configured to transmit the task parameters to a destination server according to the type of the task.

8. The client server according to claim 7,
wherein the receiving module is a first receiving module, and
wherein the transmitting module is a first transmitting module,
the client server further comprising:
a second transmitting module configured to transmit a task assignment request to a master server according to an operating status of the client server; and
a second receiving module configured to receive a processing result of the task fed back from the destination server and to transmit the processing result to the master server.

9. A method for data task processing comprising:
receiving, by a client server, a task from a master server;
parsing the task to obtain task parameters of the task, the task parameters including a type of the task; and
transmitting the task parameters to a destination server according to the type of the task.

10. The method according to claim 9, further comprising:
receiving a processing result of the task from the destination server; and
transmitting the processing result to the master server.

11. The method according to claim 10, further comprising:
transmitting a task assignment request to the master server according to an operating status of the client server.

12. The method according to claim 11, wherein receiving the task from the master server includes receiving the task from the master server in response to the task assignment request.

13. The method according to claim 11, further comprising:
retrieving, by the master server, the task from a task storage according to the task assignment request; and
transmitting the task to the client server.

14. The method according to claim 13, further comprises:
adding, by the master server, the received processing result to a log table of the task storage; and
creating, by the master server, a one-to-one mapping between the task and the processing result.

15. The method according to claim 10, further comprising:
storing, by the master server, the processing result.
